(19) United States
(12) Patent Application Publication
(10) Pub. No.: US 2011/0135272 A1
(43) Pub. Date: Jun. 9, 2011

(54) PORTABLE ELECTRONIC APPARATUS EQUIPPED WITH RECORDING FUNCTION

(75) Inventors: Nobuhiko Ichii, Osaka (JP); Naoki Ogasawara, Osaka (JP)

(73) Assignee: SANYO ELECTRIC CO.,LTD., Osaka (JP)

(21) Appl. No.: 12/960,694

(22) Filed: Dec. 6, 2010

(30) Foreign Application Priority Data
Dec. 7, 2009 (JP) 2009-277861
Dec. 25, 2009 (JP) 2009-295771

(51) Int. Cl. H04N 5/77

(52) U.S. Cl. 386/225; 386/E05.069

(57) ABSTRACT

A portable electronic apparatus according to the present invention includes a main body with a front part on which a shooting lens is provided, wherein a moving image shooting button and a still image shooting button are provided at a rear part of the main body. A moving image shooting button and a still image shooting button are provided independent from the two aforementioned recording buttons on an upper face of the main body. The moving image shooting button and the still image shooting button provided at the rear part of the main body can be operated independently from the moving image shooting button and the still image shooting button provided on the upper face of the main body.

This patent application claims priority to Japanese Patent Applications No. 2009-277861 and No. 2009-295771, the contents of which are hereby incorporated in its entirety by reference into the present application.

### BACKGROUND OF THE INVENTION

1. Field of the Invention

The present invention relates to an electronic device such as a camera or a mobile phone and, in particular, to a portable electronic apparatus equipped with a recording function.

2. Description of the Related Art

Conventionally, an electronic device equipped with a biaxial hinge mechanism and capable of folding two chassis has been proposed. For example, in a video camera capable of shooting a still image and a moving image, as illustrated in FIGS. 8 and 9, a first chassis (9) provided with a shooting lens and an operating unit (92) and a second chassis (91) provided with a liquid crystal display (93) are coupled with each other so as to be openable and closeable by a biaxial hinge mechanism (90). With the video camera, the second chassis (91) can be opened by rotationally moving the second chassis (91) around a first axis of the biaxial hinge mechanism (90) with respect to the first chassis (9) as illustrated in FIG. 8, and the orientation of the liquid crystal display can be reversed by rotationally moving the second chassis (91) in an open state around a second axis of the biaxial hinge mechanism (90) as illustrated in FIG. 9.

In addition, in the video camera described above, as illustrated in FIG. 9, a power button (94) and a stopper (95) designed to receive a back face (96) of the second chassis (91) when the second chassis (91) is folded in a reversed state illustrated in FIG. 9 are provided on a side part of the first chassis (9) in an area to be covered by the second chassis (91) in a closed state.

Providing the stopper (95) prevents the back face (96) of the second chassis (91) from impacting components of the first chassis (9) and becoming damaged when the second chassis (91) is folded in the reversed state illustrated in FIG. 9.

However, in the video camera illustrated in FIGS. 8 and 9, since the operating unit (92) for recording is only provided at the rear part of the first chassis (9), there is a problem in that while recording operations during normal angle shooting and high angle shooting are readily performed, performing a recording operation during low angle shooting is difficult.

### SUMMARY OF THE INVENTION

A portable electronic apparatus equipped with a recording function according to the present invention includes a main body with a front part on which a shooting lens is provided, wherein a recording button for moving image shooting and a recording button for still image shooting are provided at a rear part of the main body. Moreover, independent from the two aforementioned recording buttons, a recording button for moving image shooting and a recording button for still image shooting are provided on an upper face of the main body.

In a specific embodiment, the recording button for moving image shooting and the recording button for still image shooting provided on the upper face of the main body are arranged in a same alignment as the recording button for moving image shooting and the recording button for still image shooting provided at the rear part of the main body.

### BRIEF DESCRIPTION OF THE DRAWINGS

FIG. 1 is a perspective view of a closed state of a video camera that is an embodiment of the present invention;

FIG. 2 is a perspective view of an open state of the video camera;

FIG. 3 is a perspective view illustrating a state where two buttons and a button holder have been removed from a side part of a first chassis in the video camera;

FIG. 4 is a perspective view illustrating a state where a second chassis in an open state has been reversed in the video camera;

FIG. 5 is a perspective view illustrating a normal angle or high angle shooting state of the video camera;

FIG. 6 is a perspective view illustrating a low angle shooting state of the video camera;

FIG. 7 is a perspective view of an open state of a video camera that is another embodiment of the present invention;

FIG. 8 is a perspective view illustrating an open state of a conventional video camera; and

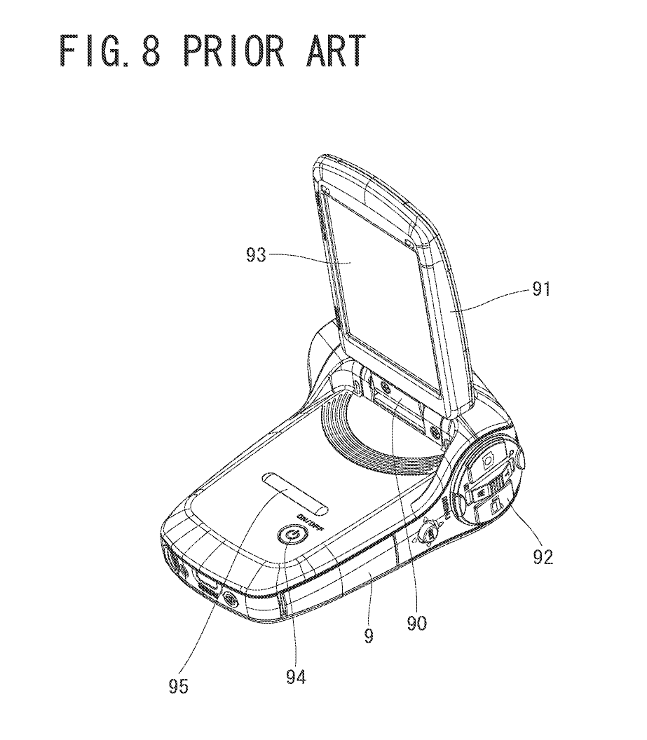

FIG. 9 is a perspective view illustrating a state where a second chassis in an open state has been reversed in the conventional video camera.

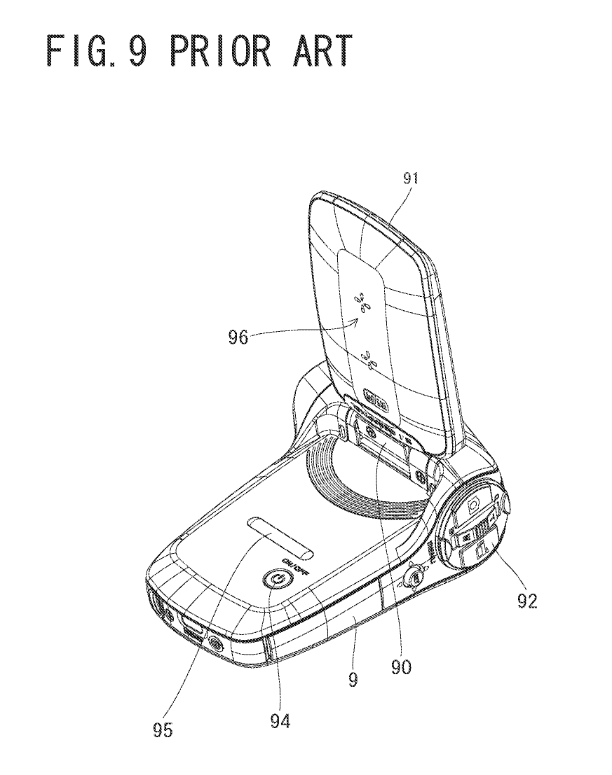

### DETAILED DESCRIPTION OF THE PREFERRED EMBODIMENTS

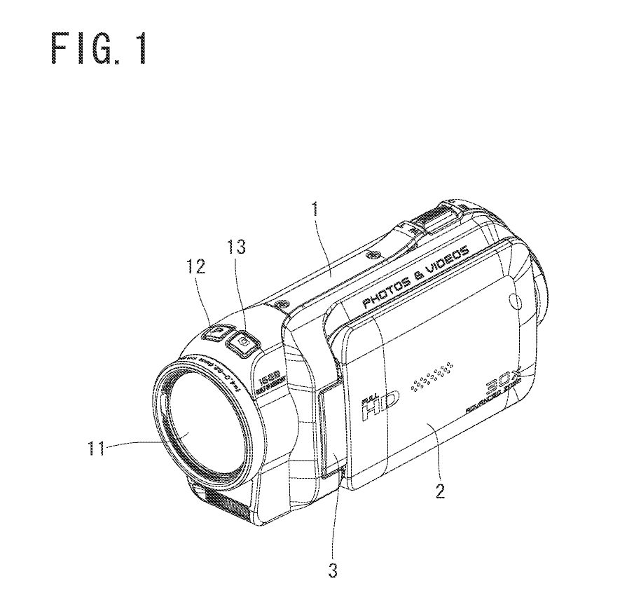

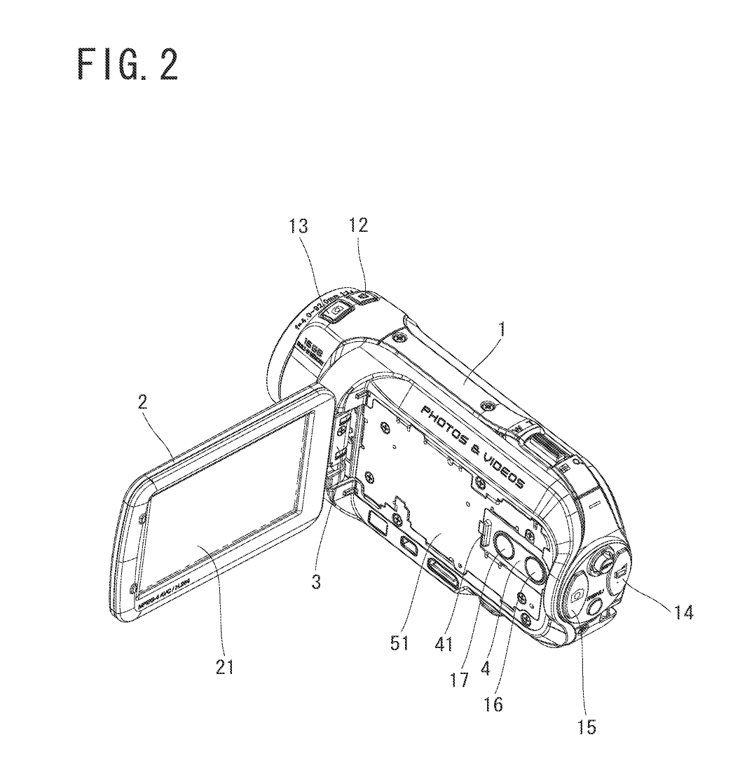

Hereinafter, embodiments of the present invention implemented on a video camera capable of shooting a still image and a moving image will be described in detail with reference to the drawings. A video camera that is an embodiment of the present invention includes, as illustrated in FIGS. 1 and 2, a first chassis (1) provided with a shooting lens (11) and a second chassis (2) provided with a liquid crystal display (21), wherein both chassis (1) and (2) are coupled with each other so as to be openable and closeable by a biaxial hinge mechanism (3).

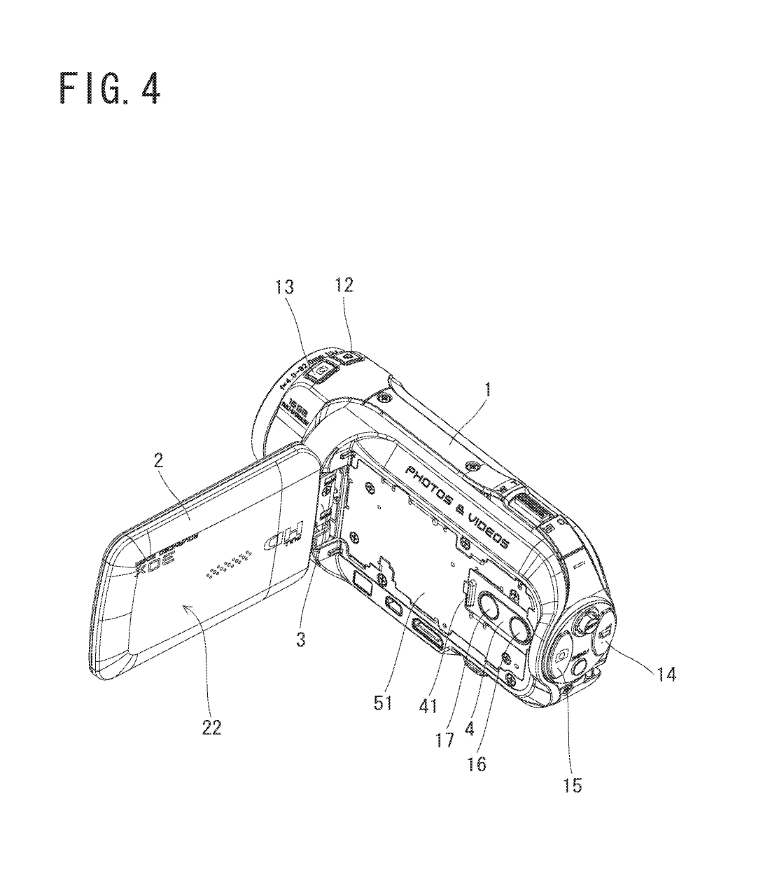

In the video camera, an operation of the biaxial hinge mechanism (3) enables a closed state illustrated in FIG. 1 and an open state illustrated in FIG. 2 to be set. In addition, by rotating the second chassis (2) from the open state illustrated in FIG. 2, the orientation of the liquid crystal display (21) can be reversed as illustrated in FIG. 4.

As illustrated in FIGS. 1 and 2, a moving image shooting button (14) and a still image shooting button (15) are provided on a back face of a rear part of the first chassis (1), and a moving image shooting button (12) and a still image shooting button (13) are also provided on an upper face of a front part of the first chassis (1).

Operations due to manipulation of the rear moving image shooting button (14) and the rear still image shooting button (15) are independent from those of the front moving image shooting button (12) and the front still image shooting button (13). For example, still image shooting can be performed during moving image shooting by manipulating the front still image shooting button (13) after starting shooting of a moving image using the rear moving image shooting button (14).

Furthermore, a power button (16) and a playback button (17) are provided on a side face of the first chassis (1) in an area to be covered by the second chassis (2) in a closed state as illustrated in FIG. 2. The buttons (16) and (17) are held by a sheet-like button holder (4).

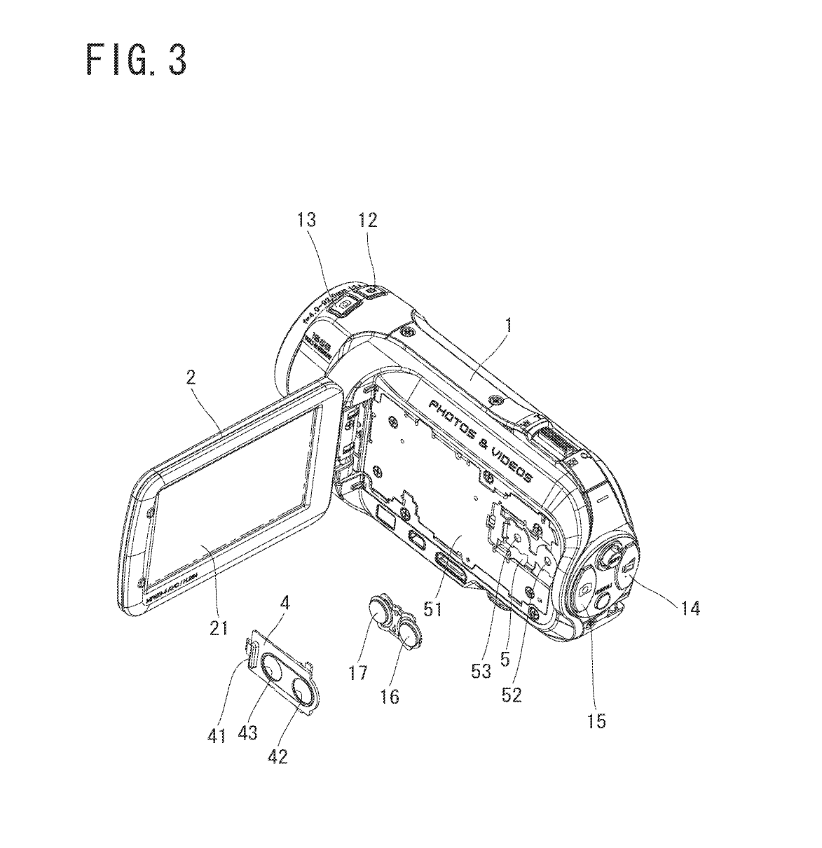

A main body mechanism unit (5) is housed inside the first chassis (1) as illustrated in FIG. 3, and a side face of the main body mechanism unit (5) is covered by a metal plate (51). The metal plate (51) functions as a heat sink that dissipates heat of the main body mechanism unit (5). Moreover, when required, a resin sheet is placed on a surface of the metal plate (51).

Two switch units (52) and (53) are provided on a side part of the main body mechanism unit (5). The switch units (52) and (53) are respectively turned on by pressing manipulations of the power button (16) and the playback button (17).

The button holder (4) holding the power button (16) and the playback button (17) is made of an elastomer, and two openings (42) and (43) from which respective heads of the power button (16) and the playback button (17) are to slightly protrude are formed on the button holder (4). A stopper (41) is protrudingly provided by integral molding on an end part of a surface of the button holder (4).

As illustrated in FIG. 4, when the second chassis (2) is folded toward the side of the first chassis (1) from a state where the second chassis (2) is opened and the orientation of the liquid crystal display (21) is reversed, the back face (22) of the second chassis (2) abuts, and is received by, the stopper (41). At this point, since the stopper (41) is formed by an elastomer, the back face (22) of the second chassis (2) remains undamaged.

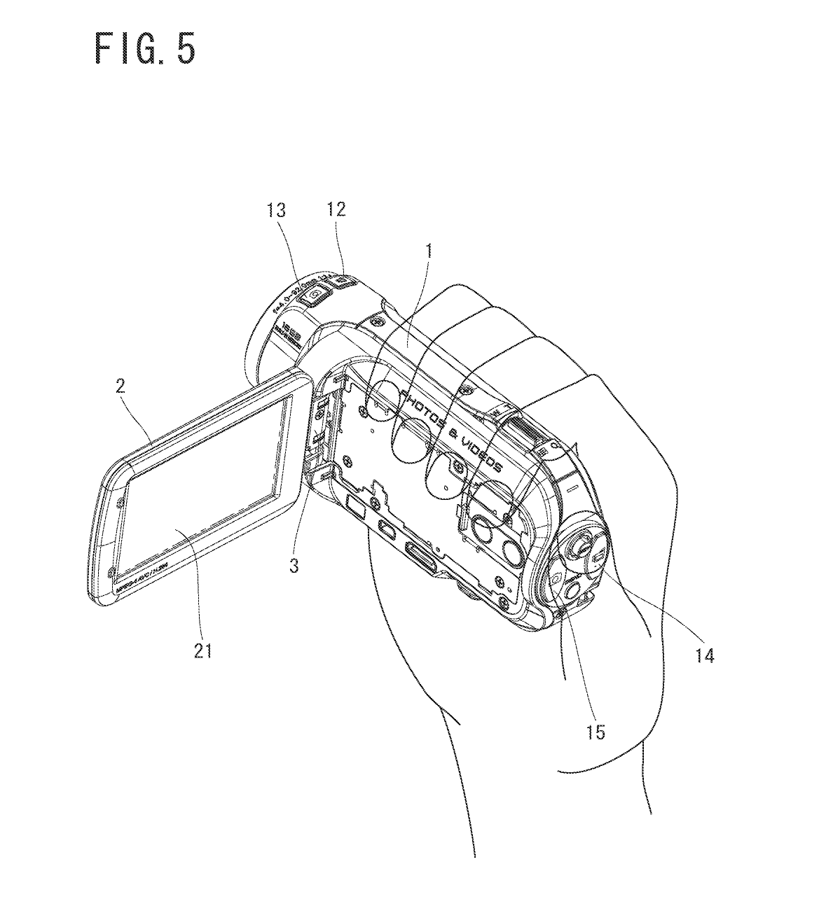

FIG. 5 illustrates a shooting state from a normal angle or a high angle of the video camera described above. A user performs shooting of a moving image or a still image by gripping the first chassis (1) from below and holding the video camera at approximately the same height position as eye level. In this case, the user need only perform a simple manipulation of the rear moving image shooting button (14) or the rear still image shooting button (15) by the thumb.

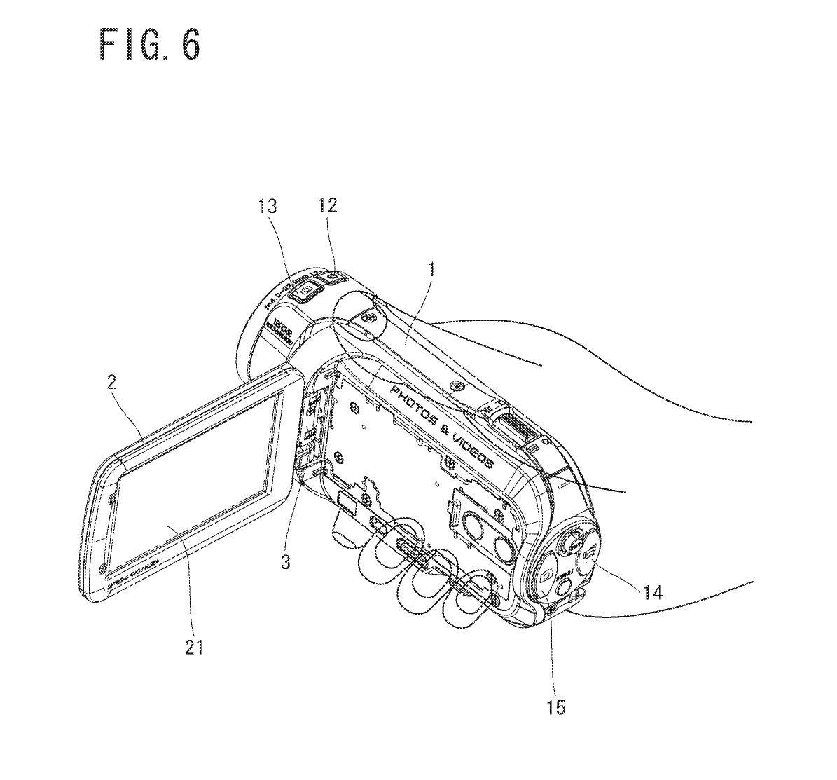

On the other hand, FIG. 6 illustrates a shooting state from a low angle of the video camera described above. A user performs shooting of a moving image or a still image by gripping the first chassis (1) from above and holding the video camera at a height position that is sufficiently lower than eye level. In this case, the user need only perform a simple manipulation of the front moving image shooting button (12) or the front still image shooting button (13) by the thumb.

Moreover, during low angle shooting, visual confirmation of an image can be readily performed by rotating the second chassis (2) from the posture illustrated in FIG. 6 and setting the liquid crystal display (21) slightly upward.

In the aforementioned video camera, since the moving image shooting button (14) and the still image shooting button (15) are provided on the back face of the rear part of the first chassis (1) and the moving image shooting button (12) and the still image shooting button (13) are provided on the upper face of the front part of the first chassis (1) as described above, angle-free shooting can be achieved. Moreover, during shooting over a long period of time, the burden on the user during shooting can be alleviated by changing orientations of the hand gripping the first chassis (1).

In particular, since the right-left alignment of the rear moving image shooting button (14) and the rear still image shooting button (15) is the same as that of the front moving image shooting button (12) and the front still image shooting button (13), the risk of an incorrect manipulation is reduced.

Moreover, in the aforementioned video camera, since the stopper (41) that is to receive the back face (22) of the second chassis (2) is integrally formed with the button holder (4), a fewer number of parts is required in comparison to a conventional video camera.

Since the button holder (4) is already provided in a conventional camera, the formation of the stopper (41) on the button holder (4) can be readily realized by partially modifying a mold.

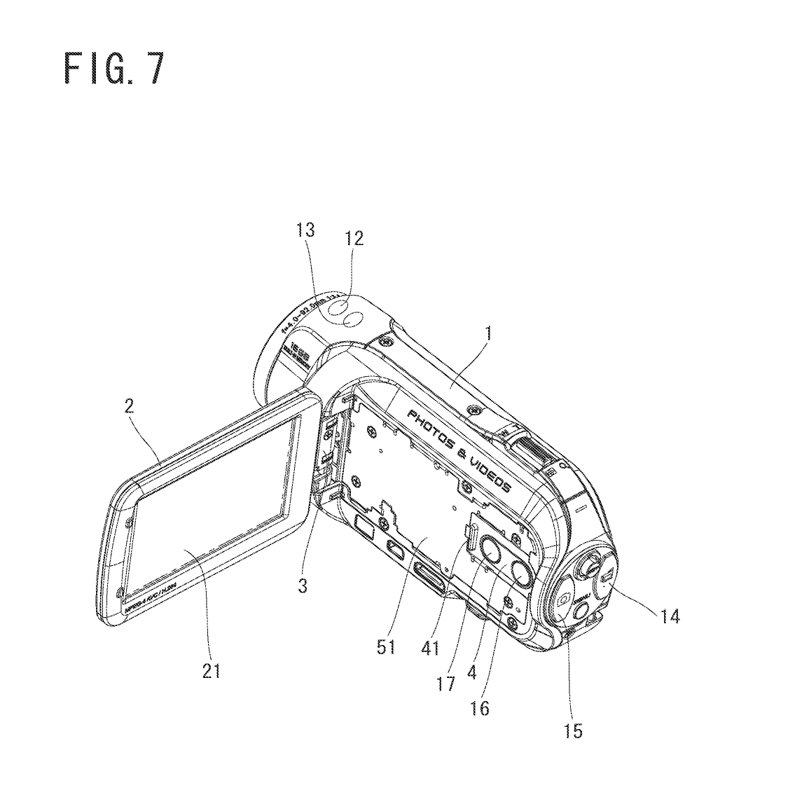

FIG. 7 illustrates a video camera that is another embodiment of the present invention, in which the rear moving image shooting button (14) and the rear still image shooting button (15) are aligned right-left but the front moving image shooting button (12) and the front still image shooting button (13) are aligned front-back. Consequently, a right-left width of a front portion of the first chassis (1) can be further reduced.

It is to be understood that the present invention is not limited to the respective components and configurations described in the above embodiments and that various modifications will be apparent to those skilled in the art without departing from the spirit or scope of the following claims. For example, the positions of the moving image shooting buttons (14) and (12) and the still image shooting buttons (15) and (13) can be alternated.

What is claimed is:

1. A portable electronic apparatus equipped with a recording function comprising a main body with a front part on which a shooting lens is provided, wherein a recording button for moving image shooting and a recording button for still image shooting are provided at a rear part of the main body, and independent from the two recording buttons, a recording button for moving image shooting and a recording button for still image shooting are provided on an upper face of the main body.

2. The portable electronic apparatus according to claim 1, wherein the recording button for moving image shooting and the recording button for still image shooting provided on the upper face of the main body are arranged in a same alignment as the recording button for moving image shooting and the recording button for still image shooting provided at the rear part of the main body.

3. The portable electronic apparatus according to claim 2, wherein an operation due to a manipulation of the recording button for moving image shooting provided on the upper face of the main body is independent from an operation due to a manipulation of the recording button for moving image shooting provided at the rear part of the main body, an operation due to a manipulation of the recording button for still image shooting provided on the upper face of the main body is independent from an operation due to a manipulation of the recording button for still image shooting provided at the rear part of the main body, and still image shooting can be performed by manipulating either of the recording buttons for still image shooting while performing moving image shooting by manipulating either of the recording buttons for moving image shooting.

4. The portable electronic apparatus according to claim 1, wherein an operation due to a manipulation of the recording button for moving image shooting provided on the upper face of the main body is independent from an operation due to a manipulation of the recording button for moving image shooting provided at the rear part of the main body, an operation due to a manipulation of the recording button for still image shooting provided on the upper face of the main body is independent from an operation due to a manipulation of the recording button for still image shooting provided at the rear part of the main body, and still image shooting can be performed by manipulating either of the recording buttons for still image shooting while performing moving image shooting by manipulating either of the recording buttons for moving image shooting.
